(19) United States
(12) Patent Application Publication
(10) Pub. No.: US 2018/0072938 A1
(43) Pub. Date: Mar. 15, 2018

(54) DUCTILE CEMENTING MATERIALS AND THE USE THEREOF IN HIGH STRESS CEMENTING APPLICATIONS

(71) Applicants: Oleg A. Mazyar, Katy, TX (US); Rostyslav Dolog, Houston, TX (US); Juan Carlos Flores Perez, The Woodlands, TX (US); Valery N. Khabashesku, Houston, TX (US); Sankaran Murugesan, Katy, TX (US)

(72) Inventors: Oleg A. Mazyar, Katy, TX (US); Rostyslav Dolog, Houston, TX (US); Juan Carlos Flores Perez, The Woodlands, TX (US); Valery N. Khabashesku, Houston, TX (US); Sankaran Murugesan, Katy, TX (US)

(73) Assignee: Baker Hughes Incorporated, Houston, TX (US)

(21) Appl. No.: 15/262,443

(22) Filed: Sep. 12, 2016

(51) Int. Cl. C09K 8/467; C04B 28/02; C04B 28/14; C04B 28/06; C04B 28/04; C04B 16/00; C04B 24/24; C09K 8/487; C09K 8/48; C09K 8/473; E21B 33/14; E21B 36/00

(52) U.S. Cl. CPC C09K 8/467; C04B 28/02; C04B 28/14; C04B 28/06; C04B 28/04; C04B 16/00; E21B 43/26; C09K 8/487; C09K 8/48; C09K 8/473; E21B 33/14; E21B 36/00; C09K 2208/10; C04B 24/24

(57) ABSTRACT

A method of cementing a wellbore penetrating a subterranean formation comprises: injecting into the wellbore a cementing composition comprising: a ductility modifying agent comprising one or more of the following: an ionomer; a functionalized carbon; a metallic fiber; or a polymeric fiber; a cementitious material; an aggregate; and an aqueous carrier.

### BACKGROUND

In the oil and gas industry, cementing is a technique employed during many phases of borehole operations. For example, cement may be employed to secure various casing strings and/or liners in a well. In other cases, cement may be used in remedial operations to repair casing and/or to achieve formation isolation. In still other cases, cement may be employed to isolate selected zones in the borehole and to temporarily or permanently abandon a borehole.

Hydraulic fracturing is a stimulation process for creating high-conductivity communication with a large area of a subterranean formation. During hydraulic fracturing, a fracturing fluid is pumped at pressures exceeding the fracture pressure of the targeted reservoir rock in order to create or enlarge fractures within the subterranean formation penetrated by the wellbore. For conventional fracturing operations, the wellbore pressure can change in a magnitude of tens of thousands of psi, creating a ballooning effect on the casing and placing the cement in the wellbore under significant amount of stress. The stress can induce micro fractures and create a gap between the cement and the casing or between cement and formation. The gap, also known as microannulus, can allow communication between zones and jeopardize the hydraulic efficiency of a cementing operation. Thus, a need exists in the art for cementing materials that can maintain their integrity under high stress conditions. It would be a further advantage if such materials can provide a reliable seal avoiding gas migration.

### BRIEF DESCRIPTION

In an embodiment, a method of cementing a wellbore penetrating a subterranean formation comprises: injecting into the wellbore a cementing composition comprising: a ductility modifying agent comprising one or more of the following: an ionomer; a functionalized filler; a metallic fiber; or a polymeric fiber; a cementitious material; an aggregate; and an aqueous carrier.

In another embodiment, a cementing composition comprises a cementitious material; an ionomer; a functionalized filler; an aggregate; and an aqueous carrier.

### BRIEF DESCRIPTION OF THE DRAWINGS

The following description should not be considered limiting in any way. With reference to the accompanying drawings, like elements are numbered alike:

FIG. 1 illustrates the crosslinking among ionomers in a cementing composition according to an embodiment of the disclosure;

FIG. 2 illustrates the crosslinking among functionalized carbon in a cementing composition according to an embodiment of the disclosure; and

FIG. 3 illustrates the crosslinking between an ionomer and functionalized carbon in an exemplary cementing composition.

### DETAILED DESCRIPTION

It has been found that issues associated with the microannulus and microfractures in conventional cement applications can be mitigated by using cementing compositions comprising a ductility modifying agent such as an ionomer; functionalized filler; a metallic fiber; a polymeric fiber; or a combination thereof. In addition to the ductility modifying agent, the cementing compositions can also contain a cementitious material; an aggregate; and an aqueous carrier. Advantageously, the cementing compositions have improved strength and improved ductility at the same time.

As used herein, ionomers are polymers that comprise ionic groups bonded to a neutral polymer backbone. The ionomers can be a homopolymer or a copolymer derived from two or more different monomers. Suitable ionic groups include a sulfonate group, a phosphonate group, a carboxylate group, a carboxyl group, a sulfonic acid group, or a phosphonic acid group. Combinations of the ionic groups can be used. The ionomers can have an ionic group content of about 0.1 wt. % to about 20 wt. %, about 0.5 wt. % to about 10 wt. %, or about 0.5 wt. % to about 5 wt. % based on the total weight of the ionomers.

Ionomers can be prepared by introducing acid groups to a polymer backbone. If needed, the acid groups can be at least partially neutralized by a metal cation such as sodium, potassium, calcium, aluminum, magnesium, barium, cesium, lithium or zinc. In some embodiments, the groups introduced are already neutralized by a metal cation. The introduction of acid groups can be accomplished in at least two ways. In a first method, a neutral non-ionic monomer can be copolymerized with a monomer that is effective to provide pendant acid groups. Alternatively, acid groups can be added to a non-ionic polymer through post-reaction modifications.

Monomers that can provide acid groups include an acid anhydride based monomer, an ethylenically unsaturated sulfonic acid, an ethylenically unsaturated phosphoric acid, an ethylenically unsaturated carboxylic acid, a monoester of an ethylenically unsaturated dicarboxylic acid, or a combination comprising at least one of the foregoing. Specific examples of the monomers that can provide acid groups include maleic acid anhydride, vinyl sulfonic acid, vinyl phosphoric acid, acrylic acid, methacrylic acid, ethacrylic acid, itaconic acid, maleic acid, fumaric acid, methyl hydrogen maleate, methyl hydrogen fumarate, and ethyl hydrogen fumarate. The aid groups can be non-neutralized, partially, or completely neutralized with a metal ion such as sodium ions, potassium ions, magnesium ions, barium ions, cesium ions, lithium ions, zinc ions, calcium ions, or aluminum ions. Ionomers can be derived from one or more monomers that can provide acid groups. Neutral non-ionic monomers can optionally be used together with acid group-containing monomers to make the ionomers. Neutral non-ionic monomers include olefins such as ethylene, propylene, butylene, butadiene, and styrene; vinyl acetate; and (meth)acrylates.

Ionic groups can also be grafted to a polymer backbone. For example, maleation is a type of grafting wherein maleic anhydride, acrylic acid derivatives or combinations thereof are grafted onto the backbone chain of a graftable polymer. In an embodiment, the graftable polymer is a polyolefin selected from polypropylene, polyethylene, or a combination thereof.

A large number of ionomers could be used in the cementing compositions, including but are not limited to: carboxylated polyolefins, sulfonated fluorinated polyolefins, sulfonated ethylene-propylene-diene (EPDM), sulfonated polystyrene, phosphonated polyolefins, and the like. Exemplary carboxylated polyolefins include ethylene acrylic acid copolymer, an ethylene methacrylic acid copolymer, and an ethylene-acrylic acid-methacrylic acid ternary copolymer. Ethylene methacrylic acid copolymers (E/MAA) are commercially available as SURLYN from DuPont or LOTEK from ExxonMobil. Exemplary sulfonated fluorinated polyolefins include sulfonated tetrafluoroethylene based fluoropolymer-copolymer such as NAFION from DuPont (CAS Number 66796-30-3).

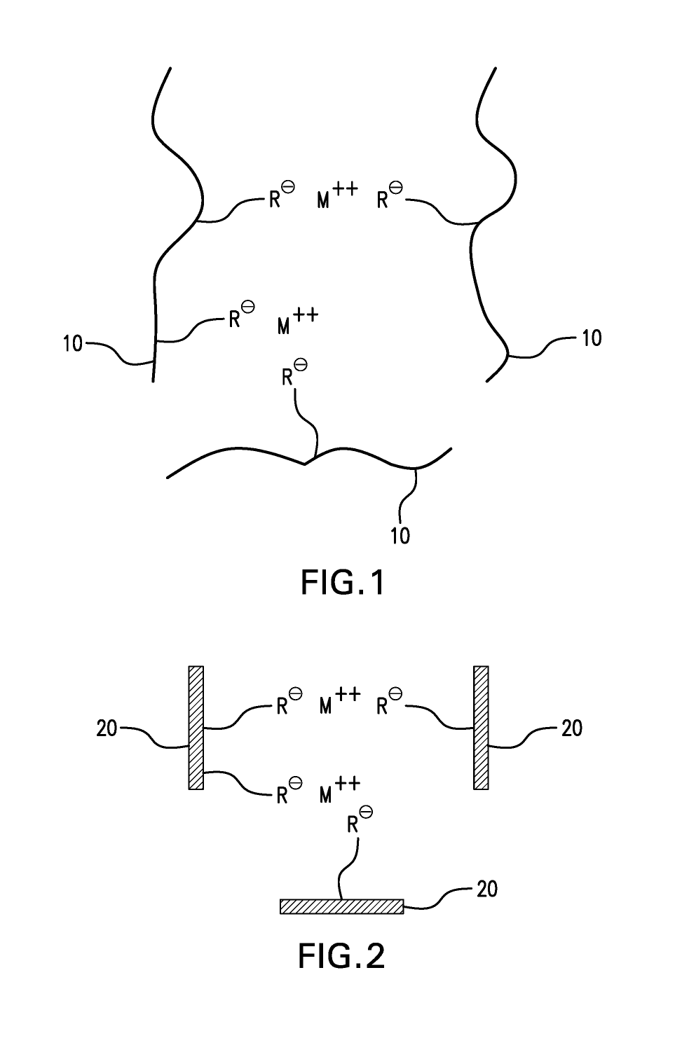

Without wising to be bound by theory, it is believed that ionic groups can microphase separate from the non-polar part of polymer chain to form ionic clusters, which can act as physical crosslinks. In addition, ionic groups can also link to the metal cations in the cementitious material or hydrated cementitious material to produce chemical crosslinks. Exemplary metal cations include calcium ions, aluminum ions, zinc ions, magnesium ions, barium ions, or a combination comprising at least one of the foregoing. In the case of bivalent metal cations, a bridge-like crosslinks can be formed linking two ionomers together or linking an ionomer with other components in the cementing composition. FIG. 1 illustrates the crosslinking of two ionomers in the cementing composition. As shown in FIG. 1, polymer chains 10 can be crosslinked via the interaction between the ionic groups R on the ionomer and the metal cation present in the cementing composition. The incorporation of the polymer chains into a cementing compositions thus can improve the ductility of the set cementing compositions.

Functionalized filler can also be used to improve the ductility and/or toughness of the cements. Functionalized filler refers to a filler functionalized with one or more functional groups. Exemplary fillers include a carbon material, clays, silica, halloysites, polysilsequioxanes, boron nitride, alumina, zirconia, or titanium dioxide. A carbon material includes a fullerene, carbon nanotube, graphite, graphene, carbon fiber, carbon black, and nanodiamonds. Combinations of different filler materials can be used. The functionalized clay, functionalized halloysites, functionalized silicate, and functionalized silica can be functionalized nanoclay, functionalized nanohalloysites, functionalized nanosilicate, or functionalized nanosilica. In an exemplary embodiment, the functionalized filler includes functionalized carbon nanotubes. Carbon nanotubes are tubular fullerene structures having open or closed ends and which may be inorganic or made entirely or partially of carbon, and may include also components such as metals or metalloids. Nanotubes, including carbon nanotubes, may be single walled nanotubes (SWNTs) or multi-walled nanotubes (MWNTs).

Functional groups include a sulfonate group, a phosphonate group, a carboxylate group, a carboxyl group, a sulfonic acid group, or a phosphonic acid group, or a combination comprising at least one of the foregoing functional groups.

As used herein, “functionalized fillers” include both non-covalently functionalized fillers and covalently functionalized fillers. Non-covalent functionalization is based on van der Walls forces, hydrogen bonding, ionic interactions, dipole-dipole interactions, hydrophobic or π-π interactions. Covalent functionalization means that the functional groups are covalently bonded to the filler, either directly or via an organic moiety.

Any known methods to functionalize the fillers can be used. For example, surfactants, ionic liquids, or organometallic compounds having the functional groups comprising a sulfonate group, a phosphonate group, a carboxylate group, a carboxyl group, a sulfonic acid group, or a phosphonic acid group, or a combination comprising at least one of the foregoing can be used to non-covalently functionalize the fillers.

In an embodiment, boron nitride is non-covalently functionalized with an organometallic compound having a hydrophilic moiety and a functional group comprising a sulfonate group, a phosphonate group, a carboxylate group, a carboxyl group, a sulfonic acid group, or a phosphonic acid group, or a combination comprising at least one of the foregoing functional groups. Exemplary hydrophilic moieties include —CH₂CH₂—O—, —CH₂—CH(OH)—O—, and —OH.

The organometallic compound used to covalently functionalize boron nitride is a compound of the formulas (I), (II), (III), or (IV)

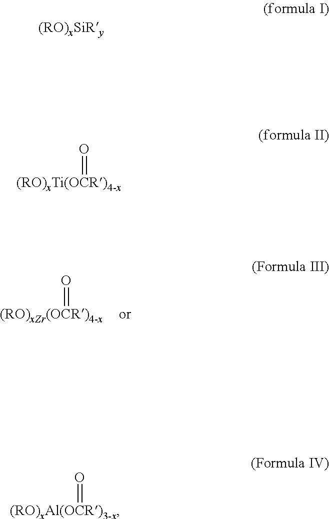

In formulas (I)-(IV), R is a hydrophilic group such as a group containing an ether group, a hydroxyl group, or a combination comprising at least one of the foregoing. An exemplary R is —CH₂—CH₂—(—O—CH₂—CH₂—O)ₖ—OH, wherein k is zero to about 30. R′ is a moiety containing a sulfonate group, a phosphonate group, a carboxylate group, a carboxyl group, a sulfonic acid group, or a phosphonic acid group, or a combination comprising at least one of the foregoing. R′ has a structure of formula (V)-(X):

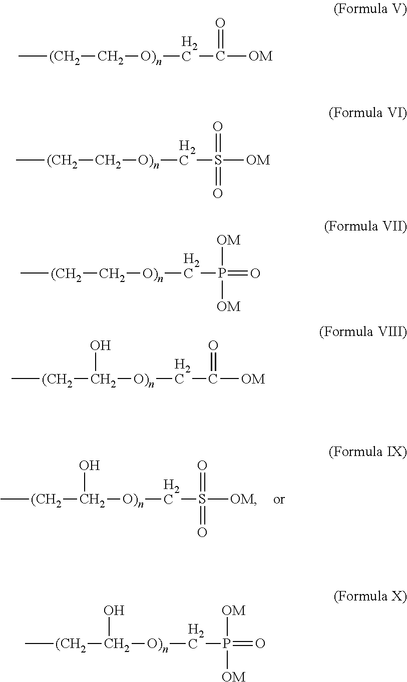

wherein each n is independently 1 to 30, 1 to 20, or 1 to 10; and each M is independently H or a metal ion such as sodium ions, potassium ions, magnesium ions, barium ions, cesium ions, lithium ions, zinc ions, calcium ions, or aluminum ions.

Various chemical reactions can be used to covalently functionalize the fillers. Exemplary reactions include, but are not limited to, oxidization, reduction, amination, free radical additions, CH insertions, cycloadditions, polymerization via a carbon-carbon double bond, or a combination comprising at least one of the foregoing. In some embodiments, the fillers are covalently functionalized. Covalently functionalized carbon is specifically mentioned. As a specific example, the functionalized filler comprises carbon nanotubes functionalized with a sulfonate group, a carboxylic acid group, or a combination thereof.

In formula (I), x+y=4, x, y are greater than zero. In formulas (II) and (III), x is 1 to 3. In formula (IV), x is 1 or 2.

The filler can be in the particle form or fiber form. In an embodiment, the filler comprises nanoparticles. Nanoparticles are generally particles having an average particle size, in at least one dimension, of less than one micrometer. Particle size, including average, maximum, and minimum particle sizes, may be determined by an appropriate method of sizing particles such as, for example, static or dynamic light scattering (SLS or DLS) using a laser light source. Nanoparticles may include both particles having an average particle size of 250 nm or less, and particles having an average particle size of greater than 250 nm to less than 1 micrometer (sometimes referred in the art as “sub-micron sized” particles). In an embodiment, a nanoparticle may have an average particle size of about 1 to about 500 nanometers (nm), specifically 2 to 250 nm, more specifically about 5 to about 150 nm, more specifically about 10 to about 125 nm, and still more specifically about 15 to about 75 nm.

In an embodiment, the functionalized carbon includes fluorinated, sulfonated, phosphonated, or carboxylated carbon nanotubes. These functionalized carbon nanotubes could link to the metal cations of in the cementitious material or in the hydrated cementitious material in a similar way as ionomers do. Exemplary metal cations include magnesium ions, barium ions, calcium ions, aluminum ions, zinc ions, or a combination comprising at least one of the foregoing. FIG. 2 illustrates the crosslinking of two functionalized carbon nanotubes in the cementing composition. As shown in FIG. 2, carbon nanotubes 20 are crosslinked via the interaction between the ionic groups R on the carbon nanotubes and the metal cation present in the cementing composition.

In an embodiment, the ductility modifying agent comprises both the functionalized filler and the ionomer. In a specific embodiment, the ductility modifying agent comprises both the functionalized carbon nanotubes and ionomers. The cementing compositions or the set cementing compositions can comprise crosslinks between ionomers, crosslinks between functionalized fillers, crosslinks between ionomers and functionalized fillers, or a combination comprising at least one of the foregoing. In an embodiment, the ionomer, the functionalized filler, or both the ionomer and the functionalized filler are crosslinked with a metal ion in the component. Exemplary metal ions include the ions of magnesium, calcium, strontium, barium, radium, zinc, cadmium, aluminum, gallium, indium, thallium, titanium, zirconium, or a combination comprising at least one of the foregoing. Preferably the metal ions include the ions of one or more of the following metals: magnesium, calcium, barium, zinc, aluminum, titanium, or zirconium. Preferably the metal ions include the ions of one or more of the following metals: magnesium, calcium, barium, zinc, aluminum, titanium, or zirconium. The metal ions can be part of the cementitious material or the hydrated cementitious material or other components such as fly ash particles as well as by incorporation salts of cations capable of crosslinking ionomers with ionomers, crosslinking functionalized fillers with functionalized fillers, or crosslinking ionomers with functionalized fillers, or a combination thereof.

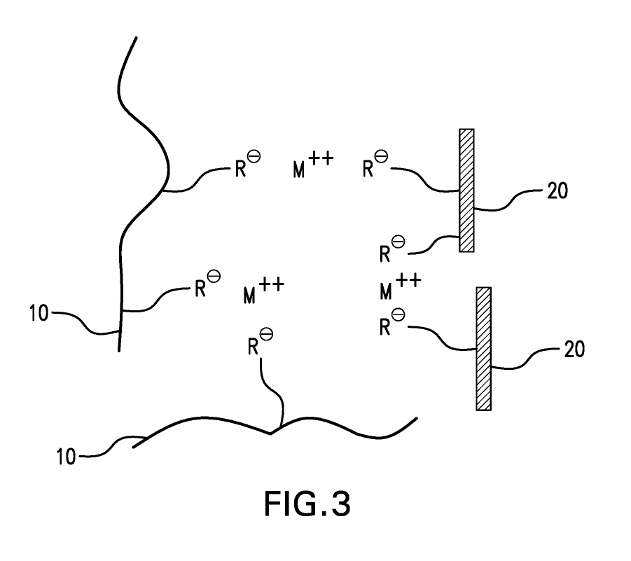

FIG. 3 illustrates the crosslinking of the ionomers and functionalized filler in a cementing composition. As shown in FIG. 3, a polymer chain 10 can be crosslinked with another polymer chain 10 or crosslinked with a functionalized filler 20. Similarly, functionalized filler 20 can be crosslinked with another functionalized filler 20 or a polymer chain 10. Without wishing to be bound by theory, it is believed the cementing compositions can have both improved ductility and improved strength when the composition contains both an ionomer and functionalized filler.

Functionalized filler, when present in the cementing compositions, can be stabilized with a stabilizing agent comprising a surfactant, surface-active particles, or a combination comprising at least one of the foregoing. Exemplary surfactants include sodium dodecylbenzenesulfonate (SDBS); sodium dodecyl sulfate (SDS); poly(amidoamine) dendrimers (PAMAM dendrimers); polyvinylpyrrolidone (PVP), naphthalenesulfonic acid, polymer with formaldehyde, sodium salt, and cetyl(triethyl)ammonium bromide (CTAB).

Surface-active particles include Janus particles and non-Janus nanoparticles. The example of Janus particles that can be used to stabilize filler in an aqueous carrier is the Janus graphene oxide (GO) nanosheets with their single surface functionalized by alkylamine. The functionalization method is described in details in Carbon, Volume 93, November 2015, Pages 473-483. Non-Janus nanoparticles that may stabilize filler in aqueous solution are hydrous zirconia nanoparticles. Without wishing to be bound by any theory, it is believed that highly charged zirconia nanoparticles segregate to regions near negligibly charged larger filler particles such as carbon particles because of their repulsive Coulombic interactions in solution and stabilize them in the solution.

The stabilizing agent can be present in an amount of about 0.1 to 10 wt % or 0.1 to 5 wt % is based on the weight of the cementing compositions. The stabilizing agent stabilizes the functionalized filler, in particular functionalized carbon in an aqueous carrier as a stabilized dispersion.

The metallic fiber comprises steel fiber or iron fiber. The polymeric fiber comprises one or more of the following: polyvinyl alcohol fiber; polyethylene fiber; polypropylene fiber; polyethylene glycol fiber; or poly(ethylene glycol)-poly(ester-carbonate) fiber. Polyvinyl alcohol fibers are specifically mentioned. The fibers can have a length of about 0.5 mm to about 20 mm or about 0.5 mm to about 3 mm, and a diameter of about 20 microns to about 200 microns or about 30 microns to about 60 microns.

The ductility modifying agent can be present in the cementing compositions in an amount of about 0.1 to about 20 wt. %, based on the total weight of the composition, preferably about 1 to about 10 wt. %, based on the total weight of the composition. In an embodiment, the cementing compositions comprise about 0.1 to about 8 or about 0.5 to about 3 vol. % of a metal fiber, based on the total weight of the cementing compositions. When the ductility modifying agent comprises the polymer fiber, the ductility modifying agent can be present in an amount of about 0.1 to about 10 or about 0.5 to about 5, based on the total weight of the cementing compositions. In an embodiment, the cementing compositions comprise about 0.1 to about 10 or about 0.5 to about 5 of an ionomer, based on the total weight of the cementing compositions. In an embodiment, the cementing compositions comprise about 0.1 to about 10 or about 1 to about 5 of functionalized carbon, based on the total weight of the cementing compositions. In yet another embodiment, the cementing compositions comprise about 0.1 to about 10 or about 1 to about 5 of a functionalized carbon and about 0.1 to about 5 wt. % of the ionomer, each based on the total weight of the cementing compositions.

The cementing compositions further comprise a cementitious material. The cementitious material can be any material that sets and hardens by reaction with water, and is suitable for forming a set cement downhole, including mortars and concretes. Suitable cementitious materials, including mortars and concretes, can be those typically employed in a wellbore environment, for example those comprising calcium, magnesium, barium, aluminum, silicon, oxygen, and/or sulfur. Such cementitious materials include, but are not limited to, Portland cements, pozzolan cements, gypsum cements, high alumina content cements, silica cements, and high alkalinity cements, or combinations of these. Portland cements are particularly useful. In some embodiments, the Portland cements that are suited for use are classified as Class A, B, C, G, and H cements according to American Petroleum Institute, API Specification for Materials and Testing for Well Cements, and ASTM Portland cements classified as Type I, II, III, IV, and V.

The cementitious material can be present in the cementing compositions in an amount of about 5 to about 60 wt. % based on the total weight of the composition, preferably about 10 to about 45 wt. % of the weight of the composition, more preferably about 15 to about 40 wt. %, based on the total weight of the composition.

The cementing compositions can contain aggregate. The term “aggregate” is used broadly to refer to a number of different types of both coarse and fine particulate material, including, but are not limited to, sand, gravel, slag, recycled concrete, silica, glass spheres, limestone, feldspar, and crushed stone such as chert, quartzite, and granite. The fine aggregates are materials that almost entirely pass through a Number 4 sieve (ASTM C 125 and ASTM C 33). The coarse aggregate are materials that are predominantly retained on a Number 4 sieve (ASTM C 125 and ASTM C 33). In an embodiment, the aggregate comprises sand such as sand grains. The sand grains can have a size from about 1 μm to about 2000 μm, specifically about 10 μm to about 1000 μm, and more specifically about 10 μm to about 500 μm. As used herein, the size of a sand grain refers the largest dimension of the grain. Aggregate can be present in an amount of about 10% to about 95% by weight of the cementing compositions, 10% to about 85% by weight of the cementing compositions, 10% to about 70% by weight of the cementing compositions, 20% to about 80% by weight of the cementing compositions, 20% to about 70% by weight of the cementing compositions, 20% to about 60% by weight of the cementing compositions, about 20% to about 40% by weight of the cementing compositions, 40% to about 90% by weight of the cementing compositions, 50% to about 90% by weight of the cementing compositions, 50% to about 80% by weight of the cementing composition, or 50% to about 70% by weight of the cementing compositions.

The cementing compositions further comprise an aqueous carrier fluid. The aqueous carrier fluid is present in the cementing compositions in an amount of about 0.5% to about 60% by weight, specifically in an amount of about 1% to about 40%, more specifically in an amount of about 1% to about 15% or about 2% to about 15% by weight, based on the total weight of the cementing compositions. The aqueous carrier fluid can be fresh water, brine (including seawater), an aqueous base, or a combination comprising at least one of the foregoing. It will be appreciated that other polar liquids such as alcohols and glycols, alone or together with water, can be used in the carrier fluid. In an embodiment, the cementing compositions comprise water in an amount of about 0.5% to about 60% by weight, specifically in an amount of about 1% to about 40%, more specifically in an amount of about 1% to about 15% or about 2% to about 15% by weight, based on the total weight of the cementing compositions.

The brine can be, for example, seawater, produced water, completion brine, or a combination comprising at least one of the foregoing. The properties of the brine can depend on the identity and components of the brine. Seawater, for example, can contain numerous constituents including sulfate, bromine, and trace metals, beyond typical halide-containing salts. Produced water can be water extracted from a production reservoir (e.g., hydrocarbon reservoir) or produced from an underground reservoir source of fresh water or brackish water. Produced water can also be referred to as reservoir brine and contain components including barium, strontium, and heavy metals. In addition to naturally occurring brines (e.g., seawater and produced water), completion brine can be synthesized from fresh water by addition of various salts for example, KCl, NaCl, ZnCl₂, ZnBr₂, MgCl₂, CaCl₂, or CaBr₂ to increase the density of the brine, such as 15 or 10.6 pounds per gallon of brine. Completion brines typically provide a hydrostatic pressure optimized to counter the reservoir pressures downhole. The above brines can be modified to include one or more additional salts. The additional salts included in the brine can be NaCl, KCl, NaBr, MgCl₂, CaCl₂, CaBr₂, ZnBr₂, NH₄Cl, sodium formate, cesium formate, and combinations comprising at least one of the foregoing. The NaCl salt can be present in the brine in an amount of about 0.5 to about 36 weight percent (wt. %), about 0.5 to about 25 wt. %, specifically about 1 to about 15 wt. %, and more specifically about 3 to about 10 wt. %, based on the weight of the brine.

The cementing compositions can further comprise various additives. Exemplary additives include a high range water reducer or a superplasticizer; a reinforcing agent, a self-healing additive, a fluid loss control agent, a weighting agent to increase density, an extender to lower density, a foaming agent to reduce density, a dispersant to reduce viscosity, a thixotropic agent, a bridging agent or lost circulation material, a clay stabilizer, ductility control agents, or a combination comprising at least one of the foregoing. These additive components are selected to avoid imparting unfavorable characteristics to the cementing compositions, and to avoid damaging the wellbore or subterranean formation. Each additive can be present in amounts known generally to those of skill in the art.

High range water reducers or superplasticizers can be grouped under four major types, namely, sulfonated naphthalene formaldehyde condensed, sulfonated melamine formaldehyde condensed, modified lignosulfonates, and other types such as polyacrylates, polystyrene sulfonates.

Reinforcing agents include fibers such as metal fibers and carbon fibers, silica flour, and fumed silica. The reinforcing agents act to strengthen the set material formed from the cementing compositions.

Self-healing additives include swellable elastomers, encapsulated cement particles, and a combination comprising at least one of the foregoing. Self-healing additives are known and have been described, for example, in U.S. Pat. No. 7,036,586 and U.S. Pat. No. 8,592,353.

Fluid loss control agents can be present, for example a latex, latex copolymers, nonionic, water-soluble synthetic polymers and copolymers, such as guar gums and their derivatives, poly(ethyleneimine), cellulose derivatives, and polystyrene sulfonate.

Weighting agents are high-specific gravity and finely divided solid materials used to increase density, for example silica flour, fly ash, calcium carbonate, barite, hematite, ilemite, sideritewollastonite, hydroxyapatite, fluorapatite, chlorapatite and the like. In some embodiments, about 15 wt. % to about 55 wt. % of wollastonite is used in the cementing compositions, based on the total weight of the cementing compositions. Hollow nano- and microspheres of ceramic materials such as alumina, zirconia, titanium dioxide, boron nitride, and carbon nitride can also be used as density reducers.

Extenders include low density aggregates as described above, clays such as hydrous aluminum silicates (e.g., bentonite (85% mineral clay smectite), pozzolan (finely ground pumice of fly ash), diatomaceous earth, silica, e.g., α quartz and condensed silica fumed silica, expanded Pearlite, gilsonite, powdered coal, and the like.

The aqueous carrier fluid of the cementing compositions can be foamed with a liquid hydrocarbon or a gas or liquefied gas such as nitrogen, or air. The fluid can further be foamed by inclusion of a non-gaseous foaming agent. The non-gaseous foaming agent can be amphoteric, cationic, or anionic. Suitable amphoteric foaming agents include alkyl betaines, alkyl sultaines, and alkyl carboxylates. Suitable anionic foaming agents can include alkyl ether sulfates, ethoxylated ether sulfates, phosphate esters, alkyl ether phosphates, ethoxylated alcohol phosphate esters, alkyl sulfates, and alpha olefin sulfonates. Suitable cationic foaming agents can include alkyl quaternary ammonium salts, alkyl benzyl quaternary ammonium salts, and alkyl amido amine quaternary ammonium salts. A foam system is mainly used in low pressure or water sensitive formations. A mixture of foaming and foam stabilizing dispersants can be used. Generally, the mixture can be included in the cementing compositions in an amount of about 1% to about 5% by volume of water in the cementing compositions.

Examples of suitable dispersants include but are not limited to naphthalene sulfonate formaldehyde condensates, acetone formaldehyde sulfite condensates, and glucan delta lactone derivatives. Other dispersants can also be used depending on the application of interest.

Clay stabilizers prevent a clay from swelling downhole upon contact with the water or applied fracturing pressure and can be, for example, a quaternary amine, a brine (e.g., KCl brine), choline chloride, tetramethyl ammonium chloride, or the like. Clay stabilizers also include various salts such as NaCl, CaCl₂, and KCl.

The pH of the cementing compositions is about 7 to about 13, about 7 to about 10, about 7 to about 9 or about 7 to about 8. A buffering agent can be optionally included in the cementing compositions. Exemplary buffering agents include 2-amino-2-hydroxmethyl-propane-1,3-diol (TRIS), phosphate, carbonate, histidine, BIS-TRIS propane, 3-(N-morpholino)propanesulfonic acid (MOPS), (4-(2-hydroxyethyl)-1-piperazineethanesulfonic acid (HEPES), 2-[[1,3-dihydroxy-2-(hydroxymethyl)propan-2-yl]amino]ethanesulfonic acid (TES), 4-(N-Morpholino)butanesulfonic acid (MOBS), 3-(N-morpholino)propanesulfonic acid (MOPS), 3-(N,N-Bis[2-hydroxyethyl]amino)-2-hydroxypropanesulfonic acid (DIPSO), N-Tris(hydroxymethyl)methyl]-3-amino-2-hydroxypropanesulfonic acid (TAPSO), triethanolamine (TEA), pyrophosphate, N-(2-Hydroxyethyl)piperazine-N′-(2-hydroxypropanesulfonic acid) (HEPPSO), piperazine-1,4-bis(2-hydroxypropanesulfonic acid) dehydrate (POPSO), tricine, glyccylglycine, bicine, N-[tris(hydroxymethyl)methyl]-3-aminopropanesulfonic acid (TAPS), taurine, ammonia, ethanolamine, glycineTRIS, piperazine-N,N′-bis(2-ethanesulfonic acid) (PIPES).

The solid content of the cementing compositions is about 50 to about 95 wt. % based on the total weight of the cementing compositions, preferably about 60 to about 90 wt. % based on the total weight of the cementing compositions, more preferably about 65 to about 85 wt. %, based on the total weight of the cementing compositions.

The density of the cementing compositions can vary widely depending on downhole conditions. Such densities can include about 5 to about 17 or about 5 to about 12 pounds per gallon when foamed. When unfoamed the density of a cementing compositions can vary with such densities between about 9 up to about 20, about 9 up to about 15 pounds per gallon, or about 10 to about 14 pounds per gallons, or about 11 up to about 13 pounds per gallon. The cementing compositions can also be higher density, for example about 15 to about 27 pounds per gallon or about 15 to about 22 pounds per gallon.

Exemplary cementing compositions are provided. In an embodiment, the cementing compositions comprise about 25 wt. % to about 30 wt. % of a cementitious material such as Portland cement, about 35 wt. % to about 45 wt. % of aggregate such as sand; about 5 wt. % to about 15 wt. % of silica fume; about 5 wt. % to about 10 wt. % of ground quartz, about 0.5 wt. % to about 3 wt. % of a high range water reducer; about 0.5 wt. % to about 3 wt. % of an accelerator; about 2 wt. % to about 10 wt. % of steel fibers; and about 1 wt. % to about 8 wt. % of water.

In another embodiment, the cementing compositions comprise about 25 to about 40 wt. % of a cementitious material such as Portland cement, about 5 wt. % to about 12 wt. % of silica fume, about 5 wt. % to about 15 wt. % of quartz powder, about 30 wt. % to about 45 wt. % of sand, 0.5 wt. % to about 7 wt. % of metal fibers, about 0.1 wt. % to about 5 wt. % of a superplasticizer, and about 1 wt. % to about 10 wt. % of water.

In still another embodiment, the cementing compositions comprise about 15 to about 40 wt. % of a cementitious material such as Portland cement, about 20 wt. % to about 40 wt. % of an aggregate such as sand; about 0.2 to about 5 wt. % of an ionomer, about 0.1 to about 10 wt. % functionalized carbon such as functionalized carbon nanotubes; and about 2 to about 15 wt. % of an aqueous carrier such as water.

By decreasing the size of the cement components, such as sand, cement, and filler particles size, and fiber diameters, greater synergy of properties can be achieved due to increased interfacial area between components, leading to improved ductility and higher strength. In some embodiments, all the solid particles in the cementing compositions have a particle size of less than about 100 microns or less than about 20 microns. The diameters of the fibers are less than about 100 microns or less than about 20 microns.

The various properties of the cementing compositions can be varied and can be adjusted according to well control and compatibility parameters of the particular fluid with which it is associated for example a drilling fluid. The cementing compositions can be used to form downhole components, including various casings, seals, plugs, packings, liners, and the like. The cementing compositions can be used in vertical, horizontal, or deviated wellbores.

In general, the components of the cementing compositions can be premixed or is injected into the wellbore without mixing, e.g., injected “on the fly” where the components are combined as they are being injected downhole. A pumpable or pourable cementing compositions can be formed by any suitable method. In an exemplary embodiment, the components of the cementing compositions are combined using conventional cement mixing equipment or equipment used in fracturing operations. The cementing compositions can then be injected, e.g., pumped and placed by various conventional cement pumps and tools to any desired location within the wellbore to fill any desired shape form. In an embodiment, injecting the cementing compositions comprises pumping the cementing compositions via a tubular in the wellbore. For example, the cementing compositions can be pumped into an annulus between a tubular and a wall of the wellbore via the tubular. Once the cementing composition has been placed and assumed the shape form of the desired downhole article, the cementing compositions are allowed to set and form a permanent shape of an article, for example, a plug.

The method is particularly useful for cementing a wellbore, which includes injecting, generally pumping, into the wellbore the cementing compositions at a pressure sufficient to displace a drilling fluid, for example a drilling mud, a cement spacer, or the like, optionally with a “lead cementing composition” or a “tail cementing composition”. The cementing compositions can be introduced between a penetrable/rupturable bottom plug and a solid top plug. Once placed, the cementing compositions are allowed to harden, and in some embodiments, forms a cement plug in the wellbore annulus, which prevents the flow of reservoir fluids between two or more permeable geologic formations that exist with unequal reservoir pressures.

In an embodiment, allowing the cementing compositions to set comprises crosslinking the ionomers, functionalized carbon, or a combination thereof via the metal ions in the cementitious material or the hydrated cementitious material as well as by incorporation salts of cations capable of crosslinking this composition. Such crosslinking can include the crosslinking between ionomers, the crosslinking between ionomers and functionalized carbon, and the crosslinking between ionomers and functionalized carbon.

The setting conditions can vary depending on the specific cementing composition used. For example, the cementing compositions can be set at a temperature of about 50 to about 450 F, more specifically, from 150 to 250 F and a pressure of about 1000 to about 50000 psi, more specifically, from 1000 to 10000 psi in about 0.5 hours to about 24 hours, more specifically, in about 1 to about 12 hours. After setting, the cementing compositions provide a cemented structure. The cemented structure can have reduced microfractures and reduced microannulus after subjecting to a pressure cycle of from greater than about 4000 psi to less than about 500 psi as compared to a reference cemented structure provided by an otherwise identical cementing composition except for not comprising the ductility modifying agent. Reduced microfractures and reduced microannulus mean reduced total areas of the microfractures and microannulus.

If necessary, a heat treatment can follow the initial setting for the material to reach its fullest strength capabilities. Without wishing to be bound by theory, it is believed that the post setting heat treatment can strength the set cement at a microscopic level. The heat treatment involves subjecting the set cementing compositions to a temperature of about 150° F. to about 1,000° F. and a pressure of about 100 psi to about 10,000 psi for about 30 minutes to about one week.

Set forth below are various embodiments of the disclosure.

### Embodiment 1

A method of cementing a wellbore penetrating a subterranean formation, the method comprising: injecting into the wellbore a cementing composition comprising: a ductility modifying agent comprising one or more of the following: an ionomer; a functionalized filler; a metallic fiber; or a polymeric fiber; the functionalized filler comprising one or more of the following: functionalized carbon; functionalized clay; functionalized silica; functionalized alumina; functionalized zirconia; functionalized titanium dioxide; functionalized silsesquioxane; functionalized halloysite; or functionalized boron nitride; a cementitious material; an aggregate; and an aqueous carrier.

### Embodiment 2

The method of Embodiment 1, wherein the metallic fiber comprises steel fiber or iron fiber.

### Embodiment 3

The method of any one of Embodiment 1 or 2, wherein the polymeric fiber comprises one or more of the following: polyvinyl alcohol fiber; polyethylene fiber; polypropylene fiber; polyethylene glycol fibers, or poly(ethylene glycol)-poly(ester-carbonate) fibers.

### Embodiment 4

The method of any one of Embodiments 1 to 3, wherein the ionomer comprises a polymer backbone formed from one or more of the following monomers: an acid anhydride based monomer; an ethylenically unsaturated sulfonic acid; an ethylenically unsaturated phosphoric acid; an ethylenically unsaturated carboxylic acid; a monoester of an ethylenically unsaturated dicarboxylic acid; ethylene; propylene; butylene; butadiene; styrene; vinyl acetate; or (meth)acrylate; and wherein the ionomer comprises one or more of the following functional groups: a sulfonate group, a phosphonate group, a carboxylate group, a carboxyl group, a sulfonic acid group, or a phosphonic acid group.

### Embodiment 5

The method of Embodiment 1, wherein the ductility modifying agent comprises both the functionalized filler and the ionomer.

### Embodiment 6

The method of any one of Embodiments 1 to 5, wherein the functionalized filler comprises one or more of the following functional groups: a sulfonate group, a phosphonate group, a carboxylate group, a carboxyl group, a sulfonic acid group, or a phosphonic acid group.

### Embodiment 7

The method of any one of Embodiments 1 to 6, wherein the cementitious material comprises one or more of the following: Portland cement; pozzolan cement; gypsum cement; high alumina content cement; silica cement; or high alkalinity cement.

### Embodiment 8

The method of any one of Embodiments 1 to 7, wherein the cementing composition further comprises, based on the total weight of the cementing composition, about 0.1 to about 10 wt. % of a stabilizing agent effective to stabilize the functionalized filler in the aqueous carrier, the stabilizer comprising a surfactant, a surface-active particle, or a combination comprising at least one of the foregoing.

### Embodiment 9

The method of any one of Embodiments 1 to 8, wherein the cementing composition further comprises an additive which comprises a reinforcing agent, a self-healing additive, a fluid loss control agent, a weighting agent, an extender, a foaming agent, a dispersant, a thixotropic agent, a bridging agent or lost circulation material, a clay stabilizer, or a combination comprising at least one of the foregoing.

### Embodiment 10

The method of any one of Embodiments 1 to 9, wherein the cementing composition remains pumpable at wellbore conditions until setting.

### Embodiment 11

The method of any one of Embodiments 1 to 10, wherein the cementing composition comprises solids in an amount of about 50 wt. % to about 95 wt. % based on the total weight of the cementing composition.

### Embodiment 12

The method of any one of Embodiments 1 to 11, wherein the cementing composition comprises about 0.5 wt. % to about 10 wt. % of the ductility modifying agent based on the total weight of the cementing composition.

### Embodiment 13

The method of any one of Embodiments 1 to 12, wherein injecting the cementing composition comprises pumping the cementing composition in a tubular in the wellbore.

### Embodiment 14

The method of any one of Embodiments 1 to 13, wherein injecting the cementing composition comprises pumping the cementing composition into an annulus between a tubular and a wall of the wellbore via the tubular.

### Embodiment 15

The method of any one of Embodiments 1 to 14, further comprising allowing the cementing composition to set.

### Embodiment 16

The method of Embodiment 15, wherein allowing the cementing composition to set comprises crosslinking metal ions present in the cementing composition with the ionomer, the functionalized carbon, or a combination comprising at least one of the foregoing.

### Embodiment 17

The method of Embodiment 15 to 16, wherein the cementing composition is set at a temperature of about 50 to about 450 and a pressure of about 1,000 to about 50,000 in about 0.5 hours to about 24 hours.

### Embodiment 18

The method of any one of Embodiments 15 to 17, further comprising subjecting a set cementing composition to a temperature of about 150° F. to about 1,000° F. and a pressure of about 100 psi to about 10,000 psi for about 30 minutes to about one week.

### Embodiment 19

A cementing composition comprising: a cementitious material; an ionomer; a functionalized filler; an aggregate; and an aqueous carrier.

### Embodiment 20

The cementing composition of Embodiment 19 further comprising, based on the total weight of the cementing composition, about 0.1 to about 10 wt. % of a stabilizing agent effective to stabilize the functionalized filler in the aqueous carrier, the stabilizer comprising a surfactant, a surface-active particle, or a combination comprising at least one of the foregoing.

### Embodiment 21

The cementing composition of Embodiment 19 to 20, wherein the ionomer comprises a polymer backbone formed from one or more of the following monomers: an acid anhydride based monomer; an ethylenically unsaturated sulfonic acid; an ethylenically unsaturated phosphoric acid; an ethylenically unsaturated carboxylic acid; a monoester of an ethylenically unsaturated dicarboxylic acid; ethylene; propylene; butylene; butadiene; styrene; vinyl acetate; or (meth)acrylate; and wherein the ionomer comprises one or more of the following functional groups: a sulfonate group, a phosphonate group, a carboxylate group, a carboxyl group, a sulfonic acid group, or a phosphonic acid group.

### Embodiment 22

The cementing composition of any one of Embodiments 19 to 21, wherein the functionalized filler has one or more of the following functional groups: a sulfonate group, a phosphonate group, a carboxylate group, a carboxyl group, a sulfonic acid group, or a phosphonic acid group.

### Embodiment 23

The cementing composition of Embodiment 22, wherein the functionalized filler comprises functionalized carbon nanotubes.

### Embodiment 24

The cementing composition of any one of Embodiments 19 to 23, wherein the ionomer is present in an amount of about 0.1 to about 10; and the functionalized carbon is present in an amount of about 0.1 to about 10, each based on the total weight of the cementing composition.

### Embodiment 25

The cementing composition of any one of Embodiments 19 to 24, wherein the cementitious material comprises one or more of the following: Portland cement; pozzolan cement; gypsum cement; high alumina content cement; silica cement; or high alkalinity cement.

### Embodiment 26

The cementing composition of any one of Embodiments 21 to 25, comprising solids in an amount of about 50 wt. % to about 95 wt. % based on the total weight of the cementing composition.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” The modifier “about” used in connection with a quantity is inclusive of the stated value and has the meaning dictated by the context (e.g., it includes the degree of error associated with measurement of the particular quantity).

What is claimed is:

1. A method of cementing a wellbore penetrating a subterranean formation, the method comprising:
injecting into the wellbore a cementing composition comprising:
a ductility modifying agent comprising one or more of the following: an ionomer; a functionalized filler; a metallic fiber; or a polymeric fiber; the functionalized filler comprising one or more of the following: functionalized carbon;
functionalized clay; functionalized silica; functionalized alumina; functionalized zirconia; functionalized titanium dioxide; functionalized silsesquioxane;
functionalized halloysite; or functionalized boron nitride;
a cementitious material;
an aggregate; and
an aqueous carrier.

2. The method of claim 1, wherein the metallic fiber comprises steel fiber or iron fiber.

3. The method of claim 1, wherein the polymeric fiber comprises one or more of the following: polyvinyl alcohol fiber; polyethylene fiber; polypropylene fiber; polyethylene glycol fibers, or poly(ethylene glycol)-poly(ester-carbonate) fibers.

4. The method of claim 1, wherein the ionomer comprises a polymer backbone formed from one or more of the following monomers: an acid anhydride based monomer; an ethylenically unsaturated sulfonic acid; an ethylenically unsaturated phosphoric acid; an ethylenically unsaturated carboxylic acid; a monoester of an ethylenically unsaturated dicarboxylic acid; ethylene; propylene; butylene; butadiene; styrene; vinyl acetate; or (meth)acrylate; and wherein the ionomer comprises one or more of the following functional groups: a sulfonate group, a phosphonate group, a carboxylate group, a carboxyl group, a sulfonic acid group, or a phosphonic acid group.

5. The method of claim 1, wherein the ductility modifying agent comprises both the functionalized filler and the ionomer.

6. The method of claim 1, wherein the functionalized filler comprises one or more of the following functional groups: a sulfonate group, a phosphonate group, a carboxylate group, a carboxyl group, a sulfonic acid group, or a phosphonic acid group.

7. The method of claim 1, wherein the cementitious material comprises one or more of the following: Portland cement; pozzolan cement; gypsum cement; high alumina content cement; silica cement; or high alkalinity cement.

8. The method of claim 1, wherein the cementing composition further comprises, based on the total weight of the cementing composition, about 0.1 to about 10 wt. % of a stabilizing agent effective to stabilize the functionalized filler in the aqueous carrier, the stabilizer comprising a surfactant, a surface-active particle, or a combination comprising at least one of the foregoing.

9. The method of claim 1, wherein the cementing composition further comprises an additive which comprises a reinforcing agent, a self-healing additive, a fluid loss control agent, a weighting agent, an extender, a foaming agent, a dispersant, a thixotropic agent, a bridging agent or lost circulation material, a clay stabilizer, or a combination comprising at least one of the foregoing.

10. The method of claim 1, wherein the cementing composition remains pumpable at wellbore conditions until setting.

11. The method of claim 1, wherein the cementing composition comprises solids in an amount of about 50 wt. % to about 95 wt. % based on the total weight of the cementing composition.

12. The method of claim 1, wherein the cementing composition comprises about 0.5 wt. % to about 10 wt. % of the ductility modifying agent based on the total weight of the cementing composition.

13. The method of claim 1, wherein injecting the cementing composition comprises pumping the cementing composition in a tubular in the wellbore.

14. The method of claim 1, wherein injecting the cementing composition comprises pumping the cementing composition into an annulus between a tubular and a wall of the wellbore via the tubular.

15. The method of claim 1, further comprising allowing the cementing composition to set.

16. The method of claim 15, wherein allowing the cementing composition to set comprises crosslinking metal ions present in the cementing composition with the ionomer, the functionalized carbon, or a combination comprising at least one of the foregoing.

17. The method of claim 15, wherein the cementing composition is set at a temperature of about 50 to about 450 and a pressure of about 1,000 to about 50,000 in about 0.5 hours to about 24 hours.

18. The method of claim 15, further comprising subjecting a set cementing composition to a temperature of about 150° F. to about 1,000° F. and a pressure of about 100 psi to about 10,000 psi for about 30 minutes to about one week.

19. A cementing composition comprising:
a cementitious material;
an ionomer;
a functionalized filler;
an aggregate; and
an aqueous carrier.

20. The cementing composition of claim 19 further comprising, based on the total weight of the cementing composition, about 0.1 to about 10 wt. % of a stabilizing agent effective to stabilize the functionalized filler in the aqueous carrier, the stabilizer comprising a surfactant, a surface-active particle, or a combination comprising at least one of the foregoing.

21. The cementing composition of claim 19, wherein the ionomer comprises a polymer backbone formed from one or more of the following monomers: an acid anhydride based monomer; an ethylenically unsaturated sulfonic acid; an ethylenically unsaturated phosphoric acid; an ethylenically unsaturated carboxylic acid; a monoester of an ethylenically unsaturated dicarboxylic acid; ethylene; propylene; butylene; butadiene; styrene; vinyl acetate; or (meth)acrylate; and wherein the ionomer comprises one or more of the following functional groups: a sulfonate group, a phosphonate group, a carboxylate group, a carboxyl group, a sulfonic acid group, or a phosphonic acid group.

22. The cementing composition of claim 19, wherein the functionalized filler has one or more of the following functional groups: a sulfonate group, a phosphonate group, a carboxylate group, a carboxyl group, a sulfonic acid group, or a phosphonic acid group.

23. The cementing composition of claim 22, wherein the functionalized filler comprises functionalized carbon nanotubes.

24. The cementing composition of claim 19, wherein the ionomer is present in an amount of about 0.1 to about 10; and the functionalized carbon is present in an amount of about 0.1 to about 10, each based on the total weight of the cementing composition.

25. The cementing composition of claim 19, wherein the cementitious material comprises one or more of the following: Portland cement; pozzolan cement; gypsum cement; high alumina content cement; silica cement; or high alkalinity cement.

26. The cementing composition of claim 21, comprising solids in an amount of about 50 wt. % to about 95 wt. % based on the total weight of the cementing composition.
